(19) United States
(12) Patent Application Publication
(10) Pub. No.: US 2025/0001609 A1
(43) Pub. Date: Jan. 2, 2025

(54) ROBOTIC APPLICATION OF TAPES

(71) Applicant: 3M INNOVATIVE PROPERTIES COMPANY, St. Paul, MN (US)

(72) Inventors: Erich A. Mielke, St. Paul, MN (US); Xin Dong, St. Paul, MN (US); John W. Henderson, St. Paul, MN (US); Brett R. Hemes, Woodbury, MN (US); Timothy J. Reddy, Maplewood, MN (US); John J. Schmidt, Stillwater, MN (US); Daniel M. Bodily, Woodbury, MN (US)

(21) Appl. No.: 18/709,449

(22) PCT Filed: Nov. 2, 2022
(86) PCT No.: PCT/IB2022/060574

§ 371 Date: May 10, 2024

Related U.S. Application Data
(60) Provisional application No. 63/264,111, filed on Nov. 16, 2021.

(51) Int. Cl. B25J 9/16; B25J 15/00; B62D 65/02

(52) U.S. Cl. CPC B25J 9/1697; B25J 9/1666; B25J 15/0019; B62D 65/022

(57) ABSTRACT

Automated systems and methods of using a tape applicator mounted on a robot arm to apply a tape onto an object surface are provided. The tape applicator, which is instructed by a controller, can automatically follow a real-time-updated tape coverage path on the object surface to optimize the tape application while the tape applicator moves along the object surface. The tape applicator can also create tabs in real time.

### BACKGROUND

Various tapes such as a masking tape or a protective tape can be applied onto object surfaces such as surfaces of car parts or replacement parts. Robotic application systems have been used to ensure the proper artistic and functional application of tapes. These tapes can be removed from the object surface by manpower or a robot system.

### SUMMARY

There is a desire to precisely apply tapes onto a contoured surface. The present disclosure provides automated systems and methods to apply removable tapes onto object surfaces such as a curved three-dimensional (3D) or contoured surface.

In one aspect, the present disclosure describes a method of applying a tape onto an object surface. The method includes positioning a robot adjacent to the object surface. The robot includes an end-effector which includes a tape applicator. The method further includes determining a tape coverage path to apply the tape on the object surface, and while moving the end-effector along a movement trajectory, determining a path feasibility of the tape coverage path, updating the tape coverage path and the movement trajectory based on the determined path feasibility, and applying the tape onto the updated tape coverage path.

In another aspect, the present disclosure describes an automated system to apply a tape onto an object surface. The system includes an end-effector comprising a tape roll and a tabbing mechanism; a vision system including one or more imaging sensors to obtain imaging data for the tape, the object surface, and the end-effector; and a controller functionally connected to the end-effector and the vision system. The controller is configured to determine a tape coverage path on the object surface, determine a movement trajectory for the end-effector, and while moving the end-effector along the movement trajectory to apply, via the end-effector, the tape onto the object surface, determine a path feasibility of the tape coverage path, update the tape coverage path based on the determined path feasibility, and apply the tape onto the updated tape coverage path.

Various unexpected results and advantages are obtained in exemplary embodiments of the disclosure. One such advantage of exemplary embodiments of the present disclosure is that an optimized tape coverage path can be automatically followed on the object surface to optimize the tape application while the tape applicator moves along the object surface. In addition, the embodiments provide improved precision of application, especially on non-planar surfaces, where a slight deviation from the desired path may lead to tape creasing or insufficient coverage. Additionally, with the optimized coverage path, a minimal amount of tape can be used to cover the area. The tape applicator can also create tabs in real time.

Various aspects and advantages of exemplary embodiments of the disclosure have been summarized. The above Summary is not intended to describe each illustrated embodiment or every implementation of the present exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 illustrates a side perspective view of an automated system including an end-effector to apply a tape onto an object surface, according to one embodiment.

FIG. 2 is a side perspective view of an end-effector to apply a tape onto an object surface, according to one embodiment.

FIG. 3A is a side perspective view of a tabbing mechanism, according to one embodiment.

FIG. 3B is a side perspective view of the tabbing mechanism of FIG. 3A.

FIG. 3C is a side perspective view of the tabbing mechanism of FIG. 3A.

FIG. 3D is a side perspective view of the tabbing mechanism of FIG. 3A.

FIG. 4A illustrates a schematic diagram of a coordinate system for the end-effector tool of FIG. 1, according to one embodiment.

FIG. 4B is a schematic diagram of a digital 3D model for a tape coverage path.

FIG. 4C is a schematic diagram of a model for a portion of a tape coverage path.

FIG. 5A illustrates a block diagram of a tape application system, according to one embodiment.

FIG. 5B illustrates a block diagram of a robot controller, according to one embodiment.

FIG. 6 illustrates a flow diagram of a method of applying a tape onto an object surface, according to one embodiment.

FIG. 7 is a block diagram of a tape application process, according to one embodiment.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently provided disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

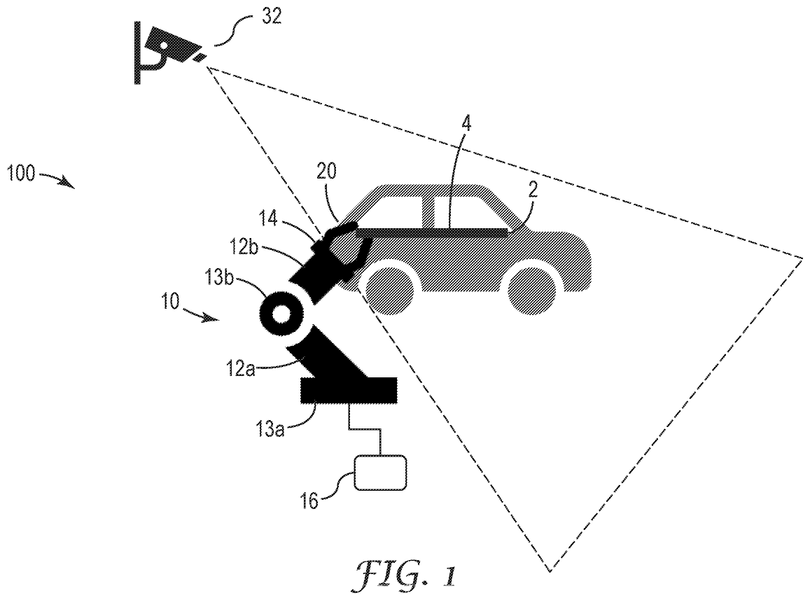

The present disclosure provides automated systems and methods to apply tapes onto object surfaces. The automated system includes a robot tape applicator for attaching a tape to the object surface, and the accompanying algorithms to ensure the proper trajectory and path is followed to properly cover the desired object surface. Tape application systems and methods described herein, such as the tape application system 100 of FIG. 1, can help to overcome some technical issues encountered in conventional tape applications. Typically, when using masking tapes to mask a curved 3D surface, there are several issues that can occur. For example, when the curvature of a tape coverage path is too high, the tape may not precisely follow the tape coverage path, and defects such as tape bubbling and/or wrinkles can occur. When the tape is relatively rigid, multiple pieces of tape may be used to account for the geometry of the tape coverage path. Tape application systems and methods described herein can precisely apply a deformable or rigid tape to follow a tape coverage path on a contoured surface. Trying to use a deformable or precision masking tape to manually apply design features can be a difficult task for a human operator. Ensuring the proper artistic and functional application of the tape can be given greater assurances by using the robotic application systems and methods described herein, which accounts for the curvature of the surface, as well as uses appropriate force to ensure proper tape wet-out on the object surface. In some embodiments, the robotic application systems and methods described herein can further create tabs for ease of removal at a later point.

FIG. 1 illustrates a side perspective view of a tape application system 100 including an end-effector 20 to apply a tape 4 onto an object surface 2. The tape application system 100 has a robot arm 10 including multiple arm sections 12a, 12b connected by joints 13a, 13b. The end-effector 20 is functionally connected to a mounting interface 14 at the distal end of the robot arm 10. The mounting interface 14 may be designed based on certain mounting standards and compatible with various end-effector tools based on the same mounting standards. In some embodiments, the mounting interface 14 may include various mechanical and electrical means to functionally connect the end-effector 20 to the robot arm 10. For example, the mounting interface may include any suitable fastening device to mechanically mount the smart end-effector 20 onto the robot arm 10. The mounting interface may further include any suitable electrical connections to communicate electrical signals between the end-effector and the robot arm or provide electrical power from the robot arm to the end-effector.

A robot controller 16 can be used to execute a robot arm command program to control the locomotion of the robot arm 10 such that a movement trajectory of the end-effector 20 can be precisely controlled. In some embodiments, the robot arm command program may control the locomotion of the robot arm 10 via a set of locomotion parameters including, for example, positions, orientations, velocities of the arm sections and joints.

In the embodiment depicted in FIG. 1, the tape application system 100 applies an adhesive tape 4 to be attached to the object surface 2. The object surface 2 can be, for example, an auto part surface (e.g., a side window surface as shown in FIG. 1). The object surface may have a planar or non-planar manifold with various surface curvatures. The robot controller 16 can control the locomotion of the robot arm such that the end-effector 20 can approach and move around the object surface 2 to apply the tape 4 onto a tape coverage path of the object surface 2. In some embodiments, the robot controller 16 may include an optional power interface to a power source thereof to provide power to the end-effector 20 in the form of electricity, pneumatic pressure, etc.

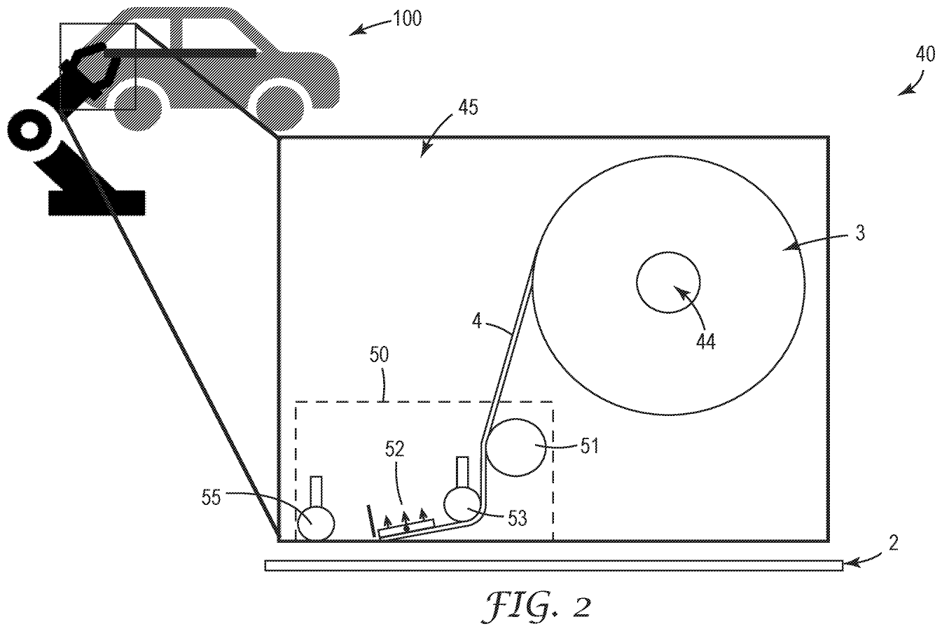

The end-effector 20 includes a robotic tape applicator such as robotic tape applicator 40 shown in FIG. 2. The tape applicator 40 is mounted onto an end plate 45 that is attached to the robot arm 10. A tape roll 3 is mounted on a motorized feeding roller 44 and attached to a servo motor for automatically unwinding the tape 4 therefrom. The tape 4, that comes out of the tape roll 3, is fed to a pressing and tabbing mechanism 50. The pressing and tabbing mechanism 50 includes a vacuum plate 52 to hold the tape 4 in place. A guiding roller 51 and a first pressing roller 53 are provided to guide the tape 4 from the tape roll 3 to the vacuum plate 52.

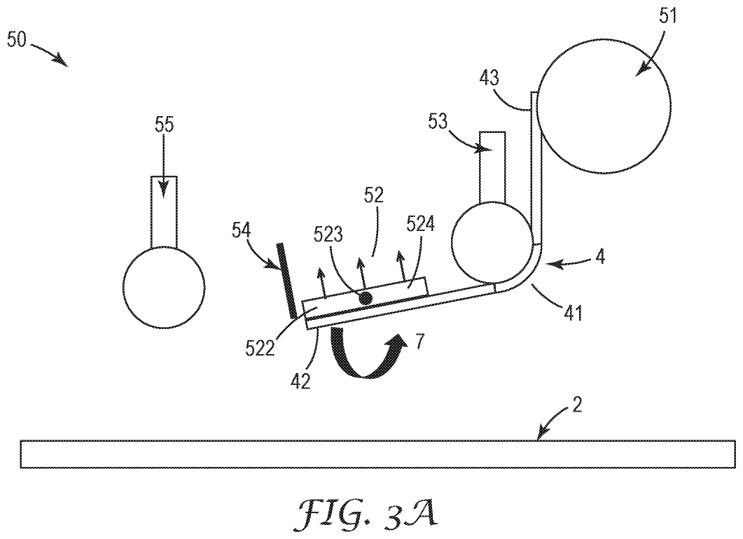

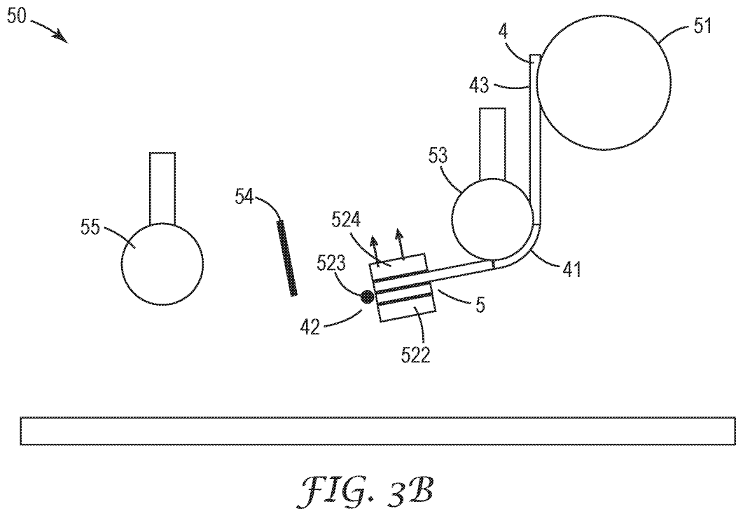

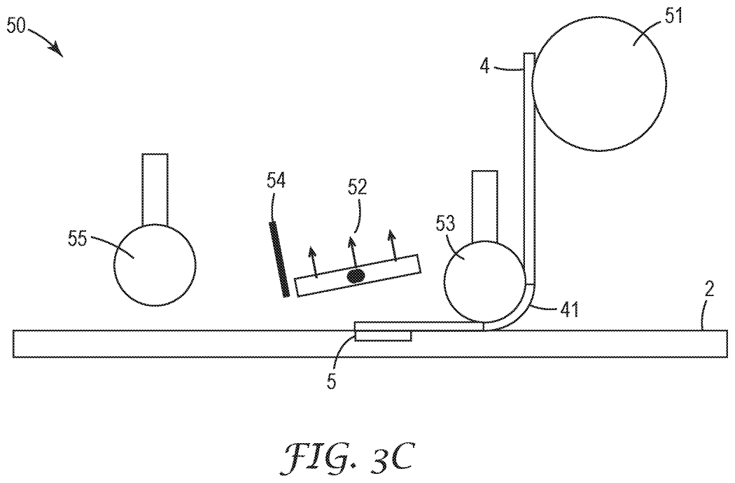

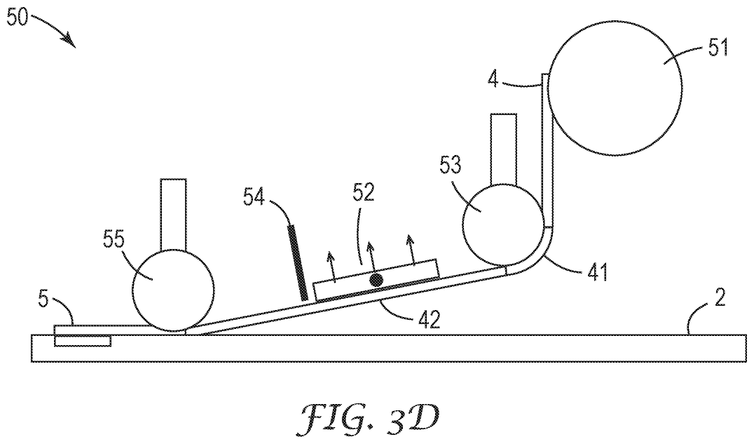

As shown in FIG. 3A, the vacuum plate 52 is configured to hold the tape head 42 on the non-adhesive side 43 of the tape 4, with the adhesive side 41 of the tape facing to the object surface 2. The vacuum plate 52 has two parts 522 and 524 that are connected to each other via a rotary joint 523. The part 524 of the vacuum plate 52 is fixed while the part 522 can be rotated with respect to the part 524 along the arrow direction 7 via a rotary motor (not shown). Upon actuation of the rotary motor, the part 522 of the vacuum plate 50 is folded on top of the part 524 such that the tape head 42 is folded to join the adjacent adhesive sides 41 and create a tab 5 at the tape head 42, as shown in FIG. 3B. While the vacuum plate 52 holds the tape head 42 in place, the pressing roller 53 presses the tape 4 down to attach the adhesive side 41 to the object surface 2, as shown in FIG. 3C. The vacuum plate 50 can then be unfolded and detached from the tape 4.

Referring to FIG. 3D, the pressing rollers 53 and 55 are provided to press the tape 4 against the object surface 2. The pressing rollers 53, 55 each can be attached to an air cylinder and actuated to tack down and wet out the tape 4 on the object surface 2. A blade 54 is attached to an air cylinder to cut the tape 4 after a desired length of tape 4 is applied on the tape coverage path of the object surface 2. Before cutting the tape 4, the vacuum plate 52 can be positioned to hold the new tape head 42 to be formed, and to create a new tab in a manner described above after the cutting.

In the embodiment depicted in FIGS. 3A-D, the pressing and tabbing mechanism 50 includes two pressing rollers 53 and 55 and one guiding roller 51. It is to be understood that other numbers and kinds of rollers can be used to apply the tape on the tape coverage path of the object surface. In some embodiments, the orientations and positions of the respective rollers such as the pressing rollers 53 and 55, can be adjusted in real time such that the tape can be controlled to precisely follow the tape coverage path of the object surface. In addition, appropriate press forces can be applied via the pressing rollers to ensure proper tape wet-out on the object surface 2. Various force sensors can be used to monitor the pressure (e.g., the force value divided by the tape width) that the applicator is applying to the tape. With the force feedback, the pressure can be adjusted in real time. In the depicted embodiment, the vacuum plate 52 is positioned between the pressing rollers 53 and 55. The blade 54 is positioned in proximate to and downstream of the vacuum plate 52.

A tab formed at the tape head can facilitate the removal of the tape from the object surface at a later point. When the attached tape 4 is removed from the object surface 2, a gripping mechanism of the end-effector 20 can grip the tape tab via, for example, a pair of gripper jaws. In various embodiments, the gripping mechanism may further include a wedge, a scraper, an air blower, or a combination thereof, to facilitate the gripping of the tape tab by the gripping mechanism. For example, the tape tab can be lifted via the air blower for gripping.

The tape 4 can be any flexible adhesive tape. The tape 4 includes an adhesive surface to be adhesively bonded to the object surface 2. The adhesive surface of the tape 4 may include any suitable adhesives such as, for example, a peelable adhesive including rubber, silicone, acrylic based adhesives, etc. The adhesive surface may include a non-stretch release adhesive such as, for example, a pressure-sensitive adhesive (PSA) or an epoxy adhesive. The adhesive face can be disposed on a flexible backing layer having sufficient flexibility to allow the adhesive face to be separated from the object surface 2. The adhesive tape 4 may also provide conformability and resiliency properties as required by desired applications.

In some embodiments, the end-effector 20 can include an unwinding mechanism for unwinding the tape 4 from the tape roll 3 as the tape application progresses. The unwinding mechanism can unwind the tape in such a speed that the length of the tape to be attached on the object surface is substantially the same as the length of the tape coverage path on the object surface.

In operation, the tape application system 100 starts by initializing communication between a robot arm and an end-effector (e.g., a tape applicator) thereof. The robot arm (e.g., the robot arm 10) and the end-effector (e.g., the end-effector 20) communicate with each other to update the respective state information. Such respective state information may include, for example, power on self-tests (POST), starting orientations and coordinate systems, a tape coverage path on the object surface, and the like. The end-effector may receive state information of the robot arm from a robot control interface of the robot arm. The state information of the robot arm may include a set of locomotion parameters including, for example, positions, orientations, or velocities of the arm sections and joints.

The working state of the end-effector when applying the tape onto the object surface can be detected via various sensors. For example, the embodiment depicted in FIG. 1 includes a vision system 32 to provide a machine vision or 3D vision sensing. The vision system 32 can capture image data of the end-effector, which can be analyzed to determine the working state of the end-effector, and to determine whether to interrupt the initialization of the robot arm by sending notifications or instructions to the robot controller to stop or adjust the locomotion of the robot arm. For example, in some embodiments, when an emergency event is detected, notification can be sent to stop the initialization.

The vision system 32 can also provide a machine vision or three dimensional (3D) vision sensing to receive user instructions regarding a tape coverage path on the object surface 2. When the vision system 32 receives an instruction from a user and determines an initial tape coverage path, instructions can be sent to the robot controller to adjust locomotion of the robot arm to position the end-effector at an initial position to prepare for the application of tape onto the initial tape coverage path.

The vision system 32 can further help to evaluate or verify the tape coverage on the object surface 2 and provide feedback to a user. The vision system 32 can obtain imaging data for the tape 4 on the object surface 2 to provide surface mapping information. For example, a 2D perspective representation or a contour of the tape 4 on the object surface 2 can be generated and processed to determine whether the tape coverage is consistent with the predetermined tape coverage path on the object surface 2. In some embodiments, the tape coverage on the object surface 2 can be determined by scanning the surface and the corresponding coordinates (x, y, z) of the tape with respect to the predetermined tape coverage path in a coordinate system of the end-effector. The determined tape coverage can be communicated to the robot controller as an input to adjust the locomotion parameters of the robot arm and the operation parameters of the end-effector.

The end-effector 20 can be mounted on a mount interface of the robot arm 10. The end-effector 20 is controlled by the locomotion of the robot arm 10 to adjust its position, orientation, movement trajectory, etc., when travelling around the object surface 2. When an initial tape coverage path on the object surface 2 is determined, instructions including an initial set of application parameters can be sent to the end-effector to move the end-effector along the initial tape coverage path to apply the tape onto the object surface.

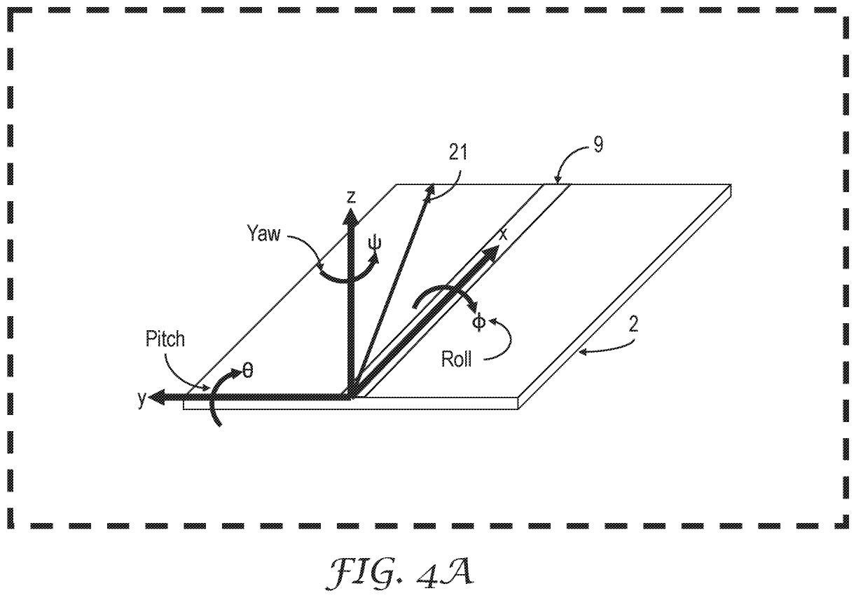

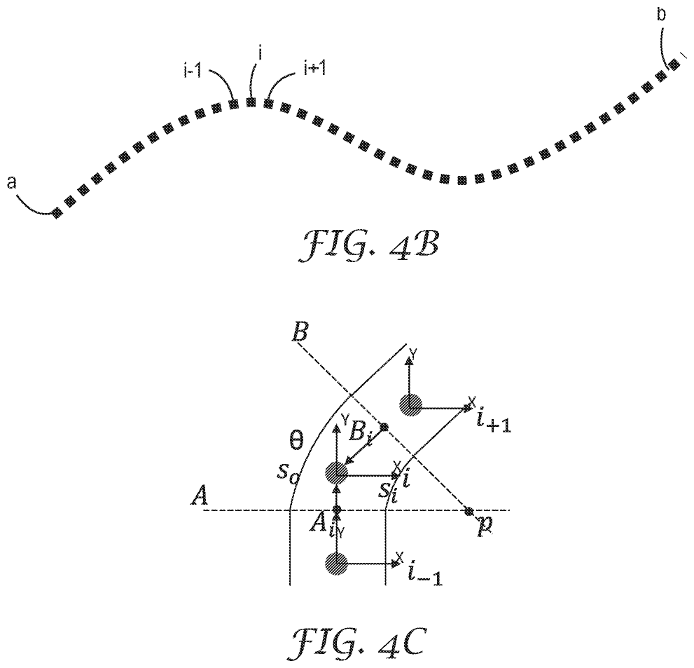

FIG. 4 illustrate a schematic diagram of various tape applicator angles/orientations in a coordinate system for an end-effector applying a tape onto an object surface. The end-effector moves along a direction 21 at a certain velocity to apply the tape to follow a tape coverage path 9. The orientation of the end-effector, the tape applicator, and any rollers of the tape applicator such as the pressing rollers 53 and 55 and guiding roller 51 in FIG. 3D, can be adjusted by changing at least one of the pitch angle θ, the yaw angle ψ, and the roll angle φ such that the movement trajectory of the end-effector is consistent with the tape coverage path 9, which may be a curved three-dimensional (3D) or contoured surface. The velocity can be in a range, for example from about 0.001 m/s to about 1.0 m/s. The pitch angle θ, the yaw angle ψ, and the roll angle φ each can be in a range, for example, from about −30 degrees to about 30 degrees.

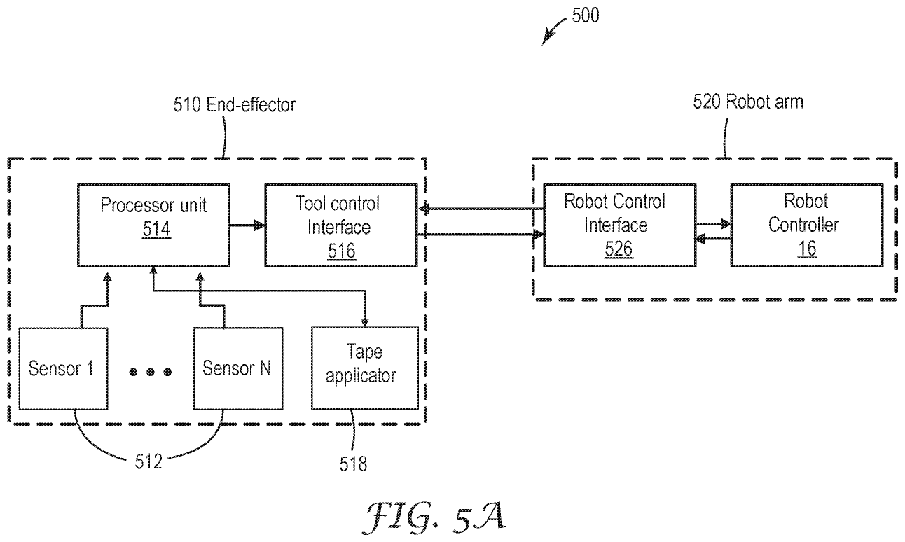

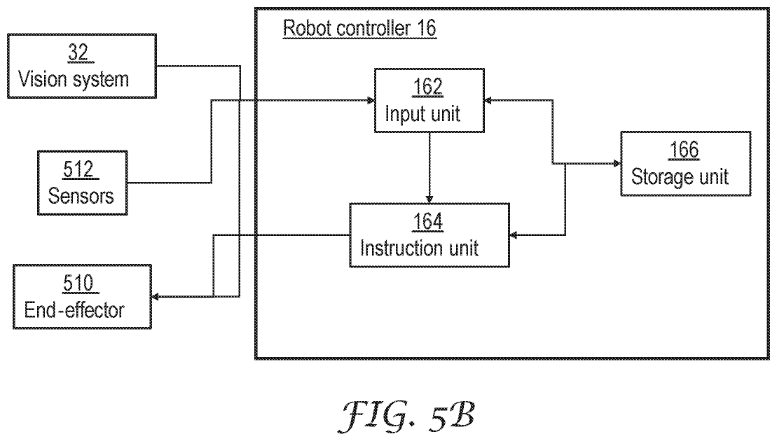

FIG. 5A illustrates a block diagram of a tape application system 500, according to one embodiment. The tape application system 500 includes an end-effector 510 functionally connected to a motive robot arm 520. The end-effector 510 includes one or more sensors 512 (e.g., Sensor 1, . . . Sensor N) to detect its working state information when applying the tape onto the object surface. The multiple sensors 512 can include, for example, a force sensor to measure the real-time force exerted to press the tape 4 against the objective surface 2. In some embodiments, a force sensor can be attached between a compliant robot flange and the tape applicator to measure the force of tape application. The force feedback can be used to monitor the pressure that the applicator is applying to the tape to ensure proper wet-out to get desired adhesion qualities. The force data may also be analyzed to determine the deformation state of the portion of the tape to be applied onto the object surface. A suitable force sensor may include, for example, a multi-axis load cell, utilizing silicon strain gauges to measure all six components of force and torque in a three-dimensional (3D) coordinate system. A force sensor may include a transducer, interface electronics, and cabling.

The sensors 512 may also include one or more imaging or vision sensors, which may be included by or supplemental to the vision system 32 of FIG. 1. In some embodiments, one or more of the vision sensors can be integrated with the vision system 32. In some embodiments, one or more of the vision sensors can be integrated with the end-effector 20 and functionally connects to the vision system 32. The vision system 32 may receive various imaging data from the imaging sensors and may process the data to obtain related information such as, for example, a 3D image model information of the object surface, state information of the tape and the object surface. For example, the vision or imaging sensors can scan the object surface to provide a 3D image model of the object surface. The image data can also be combined with a computer-implemented imaging model (e.g., CAD) of the object surface, possibly with some global registration process to ensure location of the object surface with respect to the tape applicator of the robot. The image sensor can also detect the relative position/orientation of the end-effector with respect to the object surface, and the vision system 32 can determine a real-time change in the displacement between the object surface and the end-effector based on the image data. The vision or imaging sensors located at the end-effector 20 can also detect the coverage of the tape on the object surface and communicates the imaging data to the vision system 32. The vision system 32 can determine a coverage state of the tape on the object surface based on the image data.

The sensors 512 may also include various sensors to detect environmental information such as, for example, an ambient temperature, an ambient humidity, or other conditions of the end-effector, the tape, and/or the object surface. In a working environment, one or more wireless-enabled sensing stations may be provided to include one or more sensors and a controller configured to output data indicative of sensed environmental conditions. The detected environmental condition data can be used to adjust the force exerted on the tape to stretch and press the tape against the object surface. Under varying temperature and humidity, adhesives and backings of a tape can have altered material properties, which causes the application force to change. By incorporating the environmental information, it is possible to obtain a more accurate estimate of the desired force to ensure proper tape application, e.g., without stretching the tape too much to introduce defects.

Sensing signals (e.g., analog sensor signals) from the sensors 512 are received and processed by a processor unit 514. The processor unit 514 may include an analog-to-digital converter (ADC) component to sample analog sensor signals and convert the analog sensor signals to digital signals. The processor unit 514 may further include a digital signal processing component to process and distill the digital signals to generate real-time tool state information, notifications, or instructions, and communicate the generated information to the robot controller. In some embodiments, the processor unit 514 may be integrated to the robot controller 16 and may not be located at the end-effector.

In some embodiments, the real-time tool state information generated by the processor unit 514 may include, for example, current position/orientation information of the end-effector with respect to the tape coverage path on the object surface 2. The real-time tool state information may further include a tape stretch or press force. The real-time tool state information may further include, for example, a coverage state of the tape, a real-time change in the displacement between the object surface and the end-effector, etc.

In some embodiments, the real-time notifications generated by the processor unit 514 may include, for example, position notifications (e.g., a notification to the robot controller that the end-effector is at an edge of the tape), path adjustment notifications (e.g., a notification to the robot controller that the tape recovery path is partially or completed adjusted), etc.

In some embodiments, the instructions generated by the processor unit 514 may include, for example, a tool-operation instruction regarding how to control the operation of the end-effector, a locomotion instruction to instruct the robot controller to adjust the position of the end-effector, the movement trajectory of the end-effector, a peel velocity, an orientation of the end-effector, etc. A tool-operation instruction may include, for example, an on/off instruction to the robot controller to turn on/off the end-effector, a motor control instruction to the robot controller to control the operation of a motor of the end-effector, etc.

The real-time state information, notifications, or instructions from the end-effector 510 can be sent to the robot controller 16 via the tool control interface 516 and the robot control interface 526. The robot controller 16 can then use the real-time state information to simultaneously update the locomotion parameters of the robot arm such that the movement trajectory of the end-effector 510 can be precisely controlled. The robot controller 16 can also control the tape application system 100 accordingly by taking actions upon the notification or following the instructions from the end-effector 510. In some embodiments, the robot controller 16 may receive real-time state information, notifications, or instructions from the end-effector, interpret the received information, check whether the notifications or instructions are compatible with pre-set rules, and implement instructions correspondingly. For example, the robot controller 16 may provide the end-effector with a movement vector for its position adjustment with respect to the object surface. The robot controller 16 may instruct the robot arm to provide an appropriate force for the tape applicator to press the tape against the object surface. The robot controller 16 can provide an emergency stop command to the end-effector to stop when an emergency condition is determined by the robot controller. The robot controller 16 can also instruct various parts to conduct other operations.

FIG. 5B is a block diagram of the robot controller 16, according to one embodiment. The robot controller 16 functionally connects to various parts of the system and regulates the operation of the system by various control instruments, processors, storage devices, and the like. In the depicted embodiment of FIG. 5B, the robot controller 16 includes an input unit 162 to receive various sensing data from the vision system 32, the sensors 512, and/or the end-effector 310. For example, the input unit 162 may receive imaging data from an imaging sensor regarding the tape coverage path on the object surface. The robot controller 16 further includes an instruction unit 164 to process the data received by the input unit 162 and provide instructions to the various parts of the system based on the received data.

In some embodiments, the instruction unit 164 can process the received imaging data or other sensing data related to a tape coverage path, and analyze the sensing data to determine whether there is any a collision point or an impossible curvature section on the tape coverage path. A collision point may be an area on the object surface where a desired tape repair is located that does not allow the robot and end-effector to achieve the tape application. For example, around some headlamp assemblies, the path might be put into a location where the robot arm or the end-effector cannot place the tape on the surface indicated without colliding with another object adjacent to the object surface. A collision point can be detected by running inverse-kinematics algorithms along the cartesian waypoints indicated by the desired path and checking the joint positions and robot model at each waypoint to see if any part of the robot model is in collision with any part of the environment/substrate model. An impossible curvature section may be a section with a curvature radius too low to achieve via a single tape section (using either rigid or deformable tape qualities). This section may need to be broken up into two or more sections to feasibly apply the tape along this curvature. The user may need to be alerted that this location cannot be processed using a single line of tape. Detecting this would be done pre-processing (via CAD, or image processing/3D part scanning) along with the desired adhesive path, and then using certain algorithm to determine whether the tape curvature is too high for a tape with certain deformability.

In some embodiments, the vision system 32 may obtain and process imaging data and send the processed imaging data to the input unit 162. The robot controller 16 further includes a storage unit 166 to store information including, for example, a pre-determined 3D model of the object surface, a pre-determined tape coverage path on a substrate/object surface, pre-set rules or policies, dynamically-updated state information, etc. The pre-set rules or policies can be pre-determined for various events that may occur during the application of the tape. For example, a user operating the system can set a rule that any detection of a broken tape is an urgent event.

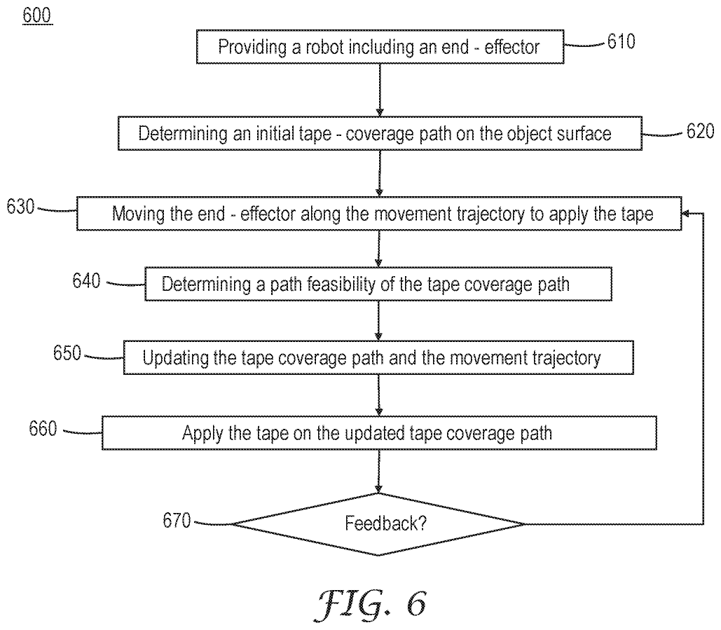

FIG. 6 illustrates a flow diagram of a method 600 of applying a tape onto an object surface, according to one embodiment. The method 600 can be implemented via various tape application systems described herein including, for example, the robotic tape applicator 40 of FIG. 2. At 610, a robot is provided with an end-effector mounted on a robot arm such as the robot arm 10 of FIG. 1. The end-effector such as the end-effector 20 of FIG. 1 is functionally connected to the distal end of the robot arm 10. The end-effector includes a tape applicator such as the tape applicator 40 of FIG. 2 configured to apply a tape on an object surface. The method 600 then proceeds to 620.

At 620, the tape application system determines an initial tape coverage path on the object surface. The tape coverage path can be a digital two-dimension (2D) or a digital three-dimensional (3D) perspective representation or a surface contour of a portion of the object surface to be covered by the tape. Such a 2D or 3D perspective representation or a contour of the object surface portion can be pre-determined and updated in real time by the vision system 32. For example, in some embodiments, the vision system may include a camera to scan the object surface to develop a 2D or 3D perspective representation or a contour of the object surface with respect to a coordinate system of the robot arm.

For the robot to know where to move in space to apply the tape in proper location and with proper application procedure, a 3D model of the object surface on which tape is applied can be provided to the system. This model can be acquired through various means including, for example, via a 3D scanning of the object surface (e.g., manually or with the robot), by using a pre-determined digital 3D model, or other suitable methods. In some embodiments, a geometry of the object surface can be represented by a digital two-dimension (2D) or a digital three-dimensional (3D) model. The digital models can be in the form of an electronic file for computer-aided design (CAD), computer-aided manufacturing (CAM), computer-aided engineering (CAE), or other suitable applications. The digital models can be pre-determined and stored, e.g., in the storage unit 166 of FIG. 5B, to be retrieved by the robot controller 16. A global part registration can be implemented by motion capture or machine vision technology, or other suitable method. This process allows the robot to know the part geometry, as well as its location in space.

The robot next needs to know where to apply the tape. In some embodiments, the system can receive specifications from a user regarding the tape coverage path in a digital three-dimensional (3D) model of the object surface. The tape coverage path in the digital 3D model can be represented by a digital dotted curve including a starting point, an ending point, and a series of waypoints connecting the starting point and the ending point. One exemplary model of a tape coverage path is shown in FIG. 4B, which includes a starting point a, an ending point b, and a series of waypoints . . . (i−1), i, (i+1) . . . connecting the starting point a and the ending point b. The user can specify the location of the tape on the object surface (i.e., the tape coverage path) via various means. For example, in some embodiments, the user can use a virtual reality (VR) device (e.g., a VR headset) to specify the tape coverage path in the 3D space of the object surface, using CAD/CAM software to trace the path via a computer, using machine vision or motion tracking to trace hand position as the user traces, or some other method.

With the specified initial tape coverage path, the system can plan initial movement trajectory for the end-effector to move with respect to the object surface. In the present disclosure, the system can plan the movement trajectory including, for example, smoothing the trajectory curve, determining constraints/feasibility on the tape coverage path, updating/informing of the feasibility of the tape coverage path, adjusting tape coverage path based on feedback, etc.

In some embodiments, the system can smooth the trajectory curve such as the curve shown in FIG. 4B. For example, depending on the input method of the tape coverage path, there may be some noise on the input waypoints, or areas that involve large spikes in acceleration or jerk or angular acceleration or jerk. The system can smooth the trajectory to remove noise, reduce acceleration/jerk, or other goals based on the user needs. Various algorithms can be used for removing noise from a signal, smoothing trajectories to minimize acceleration/jerk, and other smoothing needs.

In some embodiments, the system can determine whether the specified tape coverage path is feasible. This may involve using constraints (e.g., collision points, impossible curvature sections on the specified tape coverage path) to determine path feasibility. The system can ensure that the waypoints of a tape coverage path (and waypoints updated by the sensors) provide a path that can be traced within some deformability range of the tape. When a waypoint exceeds that range, the constraints can be relaxed. For example, the waypoint can be adjusted by moving along a tangent perpendicular to the before and after waypoints intersecting line (to maintain distance).

A tape coverage path can be considered feasible when it allows the robot to complete the trajectory with the desired application parameters. In the context of tape application, this means that the robot can apply the tape at the desired waypoints in the desired orientation, without causing collisions or undesired point-to-point issues. In other words, for properly defined path, from point-to-point there are no collisions between the robot and the object, the robot and itself, or the robot and other objects around the robot. It also means the robot maintains its relative orientation from point to point, meaning no joint-flipping (moving from a negative joint angle to a positive joint angle to meet kinematic demands) or singularity issues.

In terms of path constraints, a tape coverage path may need to be altered or corrected (either position or orientation) to meet the kinematic, application, or material demands. Kinematic demands involve possible issues of collisions, joint-flipping, singularities, joint limits, or other robot/kinematic chain constraints. To account for kinematic constraints, standard robotic planning algorithms can be used by considering robot and part geometries. Application demands include, for example, coverage of specific geometry portions, maximum deviation from nominal path, or proper tape wet-out or pressurization. Material demands include, for example, the deformability of the tape (e.g., how much the tape can stretch/compress about the longitudinal axis to achieve a curved line, while still maintaining paint-line tolerances, hold, etc.).

The tape deformability can be determined via any suitable algorithm. FIG. 4C illustrates a schematic diagram of an algorithm to determine whether a portion of a tape coverage path may introduce too much deformation for a tape to be applied thereon. The following equations can be used to determine whether the path needs to be altered to reduce possible tape deformation:

∥sᵢ−(∥Aᵢ∥+∥Bᵢ∥)∥>ϵₒ or ∥sₒ−(∥Aᵢ∥+∥Bᵢ∥)<ϵᵢ (1)

Where Si and So are an inner or outer arc length, Ai is the distance from the midpoint of tape along Ap to point i, Bi is Ai is the distance from the midpoint of tape along Bp to point i. These distances are calculated from the midpoint lines (Ap and Bp) to point i along the orthogonal vectors i−1 to i and i to i+1, ϵₒᵤₜₑᵣ is the maximum acceptable deformation or strain value for the outer edge of the tape (the edge of the tape farthest away from the center of curvature), and ϵᵢₙₙₑᵣ is the minimum acceptable deformation or strain value for the inner edge of the tape (the edge of the tape closest to the center of curvature). These deformation values can be obtained based on the material properties of the tape.

A path alteration may involve a manual or automatic process. In a manual process, the specific waypoints (e.g., point i in FIG. 4C) that caused excessive deformation may be flagged by the system to a user. The user can manually alter the tape path via a user interface until the deformation is within the specified limits. The system can also automatically alter the tape path by, for example, moving point i in a distance conserving manner (maintaining equal distances i−1 to i and i to i+1. Point i can be adjusted, for example, by moving along a secant vector pointing from the intersection of equal radius circles (of distance between points described above) about points i+1 and i−1. Possible distances to move point include moving along secant to bisector vector pointing from point i−1 to i+1, moving to opposite secant intersection point. or some fraction of this distance. One default behavior is to move to midpoint/bisector location. Less or more distance would be considered if the distance moved does not cover important geometry, collision occurs, or other valid reason. This process of adjusting the tape path may occur iteratively across whole path (excluding first and last points) wherever deformability is exceeded.

When the system determines that at least one of kinematic, material, and application constraints is violated (e.g., a desired geometry is no longer covered, or the path significantly deviates from a nominal path, etc.), the system can inform the user that the desired path is infeasible and ask for further instructions. In some cases, the system may allow the tape coverage path to be split up into usable sections and unusable sections, where the usable sections can be run, but unusable sections may need to be covered manually, or the path may need to be manually re-configured via the tape coverage definition step techniques.

Based on the determined path feasibility, the system can provide feedback to the user including, for example, suggesting an alternative or better path, updating and presenting the path, informing the user to manually change the path, etc. Based on the determined initial tape coverage path, the tape application system further determines an initial movement trajectory for the end-effector with respect to the object surface. In some embodiments, the robot can be initialized by providing an initial movement trajectory matching the tape coverage path. The initial movement trajectory provides a path in the robot coordinate system to move the end-effector. The initial movement trajectory of the end-effector can be determined based on the initial tape coverage path on the object surface at 620. When the initial tape coverage path and the corresponding movement trajectory for the end-effector are determined, the method 600 then proceeds to 630.

At 630, the robot controller 16 can instruct the robot arm to move the end-effector along the movement trajectory to apply the tape onto the object surface. The system can start by initializing the robot to position the end-effector and prepare for the application of the tape onto the object surface. The robot controller 16 can communicate with various parts of the system such as, the robot arm, the end-effector, the vision system, and various sensors to update the respective position/location information, state information, and other related information. The method 600 then proceeds to 640.

At 640, while the end-effector moves along the movement trajectory to apply the tape onto the object surface, the system determines the path feasibility of the tape coverage path at real time in similar manners as discussed above at 620. In some embodiments, the vision system 32 can scan the path and detect any constrains on applying the tape such as, for example, collision points, impossible curvature sections along the tape coverage path in real time. When the system determines that the path feasibility violates some pre-determined constrains, in some embodiments, the system can provide notifications to the user and/or receive the user's instructions regarding updating the tape coverage path. In some embodiments, the system can automatically adjust or correct the tape coverage path or the applicator's position to meet the constrains. For example, the tape coverage waypoints may be updated by the following process. Sensors of the system may look ahead of the current waypoint of the tape path, and the system determines that the sensed substrate features do not align with the pre-processing model, the waypoints may be updated (e.g., XYZ position and RPY orientation are all possible updates). These parameters may then be placed in certain deformability equations to determine arc length of the inner and outer edges of the tape between the two waypoints. If the arc lengths were within the deformability tolerance, then the path may continue with the updated orientation. If not, the system may either stop processing and wait for further instruction, or cut the tape line and being a new one at that waypoint. The method 600 then proceeds to 650.

At 650, the system updates the tape coverage path automatically based on the determined path feasibility or based on the user's instructions. The movement trajectory of the end-effector can be adjusted accordingly. The method 600 then proceeds to 660.

In some cases, the system can automatically update the path and inform a user the update. In some cases, the system can inform the user that the constraints are violated and allow the user to update the path via manual intervention. The tape coverage path can be updated/modified such that the kinematic. application and material constraints can be satisfied. Kinematic constraints can often be met by filtering/smoothing and/or slight movements of problem waypoints. These constraints, if not met, can also be solved by user alteration of problem waypoints (e.g., manually adjusting position or orientation of waypoints to meet conditions). Manual correction may not be done in real-time, as this is prohibitive to the real-time feedback, and this can only be a pre-processing routine. Application constraints can be met by ensuring desired geometries and paths are aligned properly both in the model, and then in the real part. Material constraints on the deformability of a tape can have an effect on what trajectories are possible. When a curved segment exceeds the deformability of a tape, and kinematic or application constraints may be violated by path alteration, either multiple paths need to be used, in which case the system can automatically split into multiple paths, or the user can be informed the path is infeasible as designed.

At 660, the system instructs the tape applicator to apply the tape on the updated tape coverage path. In some embodiments, when the system detects that the tape applicator is at the start point of a new section on the tape coverage path, the tape can be loaded into a tab mechanism to create a tab at an edge of the tape. In some embodiments, when the system detects that the tape applicator is at the end point of the new section on the tape coverage path, the tape applicator can cut the tape via a blade. The method 600 then proceeds to 670.

At 670, while the tape applicator applies the tape onto the object surface, the system determines real-time tool state information based on various sensor data or feedback. The real-time tool state information may include, for example, current position/orientation information of the end-effector with respect to the tape coverage path on the object surface. The real-time tool state information may further include the tape stretch or press force information. The real-time tool state information may further include. for example, a coverage state of the tape on the object surface, a real-time change in the displacement between the object surface and the end-effector, etc. For example, when the vision system 32 detects that the object surface on which the tape is to be applied moves during the application, the system can adjust the movement trajectory of the end-effector accordingly such that the end-effector can follow the tape coverage path on the object surface. The vision system 32 can further monitor the application process and provide the related orientation/location/state information of the tape applicator with respect to the object surface such that the robot controller 16 can change the locomotion parameters of the robot arm, and/or adjust the orientation/location of the tape applicator with respect to the object surface. The vision system 32 can further provide feedback related to the tape coverage by presenting the imaging date to the user. The user can adjust the operation of the robotic system accordingly.

In some embodiments, while the tape applicator applies the tape onto the object surface, the robot controller 16 instructs various sensors (e.g., the vision system 32, the sensors 512, etc.) to provide feedback regarding possible positional error introduced into the model due to variations between nominal/modeled parts and the actual part. The errors may be introduced in the scanning step, manufacturing step, or positioning of the part/robot. Due to this variable positioning, proper application pressure or tape location needs to be ensured.

One type of feedback is the force feedback that involves a force sensor used to measure the force of tape application. The force feedback can be used to monitor the pressure that the applicator is applying to the tape to ensure proper wet-out to get desired adhesion qualities. Upper and lower pressure limits can be set based on allowable tolerances around a nominal desired pressure.

Based on the monitored pressure, the system can adjust the end-effector distance along the surface normal by some correction distance for the next point in the trajectory when the pressure range is exceeded at either extreme. The correction distance can be calculated by multiplying the difference between the current pressure value and the upper or lower limit (depending on if the pressure exceeds the upper or lower limit, respectively) and some gain value. The equation then follows a standard proportional gain equation:

$$d = ( {P}_{current} - {P}_{limit} ) * G \qquad ( 2 )$$

Where d is the correction distance, P_{current} is the measured pressure, Pₗᵢₘᵢₜ is the upper or lower pressure limit, and the gain G is some value set by the user. Default gain values are determined by using the maximum expected distance deviation (e.g., the maximum difference expected between the actual part and the 3D model) and multiplying by the average of the upper and lower pressure limits. Users may want to increase this or decrease the gain to be more or less aggressive as desired. In some cases where oscillations are a concern, a proportional derivative (PD) loop can be employed by using the current time derivative of pressure multiplied by another gain H (e.g., with a default value about 1/10^{th} of first gain G):

$$d = ( {P}_{current} - {P}_{limit} ) * G + {\dot{P}}_{current} * H \qquad ( 3 )$$

While the force feedback controlled the surface normal position of the applicator with respect to the object surface, a vision feedback can be employed to achieve tracking of the position. Various vision sensors may include, for example, a machine vision camera, a 3D sensor, a motion tracking sensor, or other sensors that give position as a feedback value to be compared to the desired trajectory. Limits are set based on maximum allowable deviation of path from nominal trajectory. The vision system tracks the applied tape location and compares it to the desired location from the planned trajectory.

Similar to the force feedback, the position feedback has a formula to determine how much next point should be altered in the x or y direction (in waypoint frame of reference):

$$d = ( {x}_{current} - {x}_{limit} ) * G \qquad ( 4 )$$

where d is the correction distance, X_{current} is the measured position, Xₗᵢₘᵢₜ is the upper or lower position limit, and here the gain G is some value set by the user. Default gain value is typically about one. Users may want to increase this or decrease the gain G to be be more or less aggressive as desired. In some cases where oscillations are a concern, a PD loop can also be employed by using the current cartesian velocity multiplied by another gain (default value 1/10^{th} of first gain):

$$d = ( {x}_{current} - {x}_{limit} ) * G + {\dot{x}}_{current} * H \qquad ( 5 )$$

The vision feedback can also incorporate the tape deformability concerns as well, and after updating remaining path points via the algorithm shown, the deformability checks can be run. If any violations occurred, the deformability correction previously described can also be run across the remaining path points. If, after vision feedback correction of path occurs, the path is no longer feasible, the process can abort, and (based on user preferences) can start a new tape segment with remaining path, or the user can be informed the desired path is not possible to run.

In some embodiments, while the tape applicator applies the tape onto the object surface, the robot controller 16 instructs various sensors (e.g., the vision system 32, the sensors 512, etc.) to monitor and determine a state of the tape applicator and the tape applied on the object surface. According to the monitored state, the robot controller 16 can provide various instructions to the associated parts. For example, in one case, the robot controller 16 can receive sensor data from the sensors and process the data to verify that the real coverage of the tape is substantially consistent with the predetermined tape coverage path on the object surface. In another case, the robot controller 16 can detect whether an event occurs that renders an adjustment of the system. For example, the robot controller 16 can process the sensor data to detect a movement of the object surface during the application of the tape that renders a bad path for the end-effector. The robot controller 16 can instruct the robot arm to adjust the location of the end-effector to accommodate such a displacement. When the automatic adjustment is not successful, the robot controller 16 can send a notification regarding the state. In various embodiments, the robot controller 16 can receive sensing data from various environmental sensors to determine various environmental conditions including. for example, an ambient temperature and an ambient humidity.

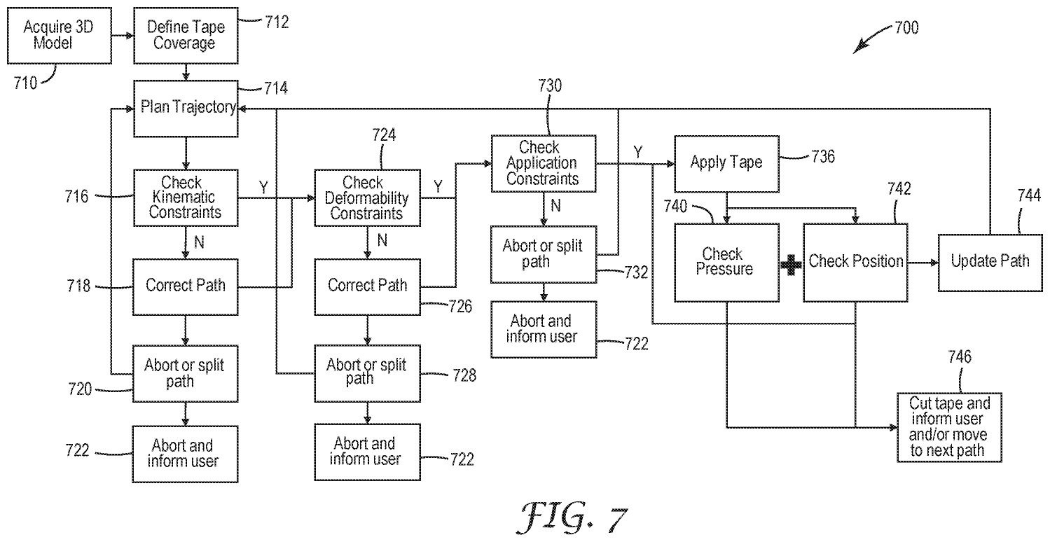

FIG. 7 is a block diagram of a tape application method 700, according to one embodiment. The method 700 can be implemented via various tape application systems described herein including, for example, the robotic tape applicator 40 of FIG. 2. It is to be understood that any steps or sub-steps of the method 700 can be combined in any suitable manner with the steps or sub-steps of the method 600 of FIG. 6 to arrive at various methods or processes suitable for applying a tape onto an object surface.

At 710, a tape application system acquires a digital 3D model of an object surface where the tape is to be applied. At 712, the system determines an initial tape coverage path on the object surface. At 714, the system determines a movement trajectory for the robotic tape applicator. At 716, the system determines whether the planned movement trajectory or tape coverage path satisfies kinematic constraints. When the system determines that violations exist for the kinematic constraints, the method 700 proceeds to 718. When the system determines that violations do not exist for the kinematic constraints, the method 700 proceeds to 724. At 718, the system determines whether to correct or adjust the tape coverage path to satisfy the kinematic constraints. When the system determines that it is not feasible to correct or adjust the tape coverage path, the method 700 proceeds to 720. At 720, the system determines whether to abort the tape application or split the tape coverage path into usable sections and unusable sections. When the system determines to abort the tape application, the method 700 proceeds to 722. When the system determines that it is feasible to correct or adjust the tape coverage path, the method 700 proceeds to 724. At 722, the system determines to abort the tape application or initiate a new tape application and inform the user. When the system determines to split the tape coverage path into usable sections and unusable sections, the method 700 proceeds to 714.

When the system determines that violations do not exist for the kinematic constraints, or the system determines that it is feasible to correct or adjust the tape coverage path, the method 700 proceeds to 724. At 724, the system determines whether the planned movement trajectory or tape coverage path satisfies tape deformability constraints. When the system determines that violations exist for the tape deformability constraints, the method 700 proceeds to 726. At 726, the system determines whether to correct or adjust the tape coverage path to satisfy the tape deformability constraints. When the system determines that it is not feasible to correct or adjust the tape coverage path, the method 700 proceeds to 728. When the system determines that it is feasible to correct or adjust the tape coverage path, the method 700 proceeds to 730. At 728, the system determines whether to abort the tape application or split the tape coverage path into usable sections and unusable sections. When the system determines to abort the tape application, the method 700 proceeds to 722. When the system determines to split the tape coverage path into usable sections and unusable sections, the method 700 proceeds to 714.

When the system determines that violations do not exist for the tape deformability constraints, or the system determines that it is feasible to correct or adjust the tape coverage path, the method 700 proceeds to 730. At 730, the system determines whether the planned movement trajectory or tape coverage path satisfies tape application constraints. When the system determines that violations exist for the tape application constraints, the method 700 proceeds to 732. When the system determines that violations do not exist for the tape application constraints, the method 700 proceeds to 736. At 732, the system determines whether to abort the tape application or split the tape coverage path into usable sections and unusable sections. When the system determines to abort the tape application, the method 700 proceeds to 722. When the system determines to split the tape coverage path into usable sections and unusable sections, the method 700 proceeds to 714.

When the system determines that violations do not exist for the tape application constraints, the method 700 proceeds to 736. At 736, the system runs to apply the tape onto the object surface. While applying the tape, at 740, the system checks the pressure used to apply the tape in real time under certain force feedback algorithm. While applying the tape, at 742, the system checks the tape position in real time under certain vision feedback algorithm. When the system determines that both the pressure and the position are proper, and that it is not the end of the movement trajectory, the method 700 proceeds to 736, continuing to apply the tape, e.g., by moving the applicator to the next waypoint of the path. When the system determines that at least one of the pressure and the position is improper, and that it is not the end of the movement trajectory, the method 700 proceeds to 744. At 744, the system determines to adjust or update the applicator movement trajectory or the tape coverage path, and the method 700 proceeds to 714. When the system determines that it is not the end of the movement trajectory, the method 700 proceeds to 746 where the tape is cut, the status is informed to the user, and the system moves to the next tape application.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but rather is to be controlled by the limitations set forth in the claims and any equivalents thereof.

### LISTING OF EXEMPLARY EMBODIMENTS

Exemplary embodiments are listed below. It is to be understood that any one of embodiments 1-13and 14-18 can be combined.

Embodiment 1 is a method of applying a tape onto an object surface, the method comprising:
positioning a robot adjacent to the object surface, the robot comprising an end-effector, the end-effector comprising a tape applicator;
determining a tape coverage path to apply the tape on the object surface; and
while moving the end-effector along a movement trajectory,
   determining a path feasibility of the tape coverage path;
   updating the tape coverage path and the movement trajectory based on the determined path feasibility; and
   applying the tape onto the updated tape coverage path.

Embodiment 2 is the method of embodiment 1, wherein determining the tape coverage path on the object surface further comprises receiving specifications from a user regarding the tape coverage path in a three-dimensional (3D) model of the object surface.

Embodiment 3 is the method of embodiment 1 or 2, further comprising obtaining, via a vision system, imaging data of the tape, the object surface, and the end-effector.

Embodiment 4 is the method of embodiment 3, further comprising verifying a coverage of the tape on the tape coverage path based on the imaging data.

Embodiment 5 is the method of anyone of embodiments 1-4, wherein determining the path feasibility comprises determining at least one of a collision point and a curvature section on the tape coverage path.

Embodiment 6 is the method of anyone of embodiments 1-5, wherein determining the path feasibility further comprises detecting a deformation of the tape.

Embodiment 7 is the method of anyone of embodiments 1-6, wherein determining the path feasibility further comprises detecting a movement of the object surface during the application of the tape.

Embodiment 8 is the method of anyone of embodiments 1-7, wherein determining the path feasibility further comprises determining environmental conditions including an ambient temperature and an ambient humidity.

Embodiment 9 is the method of anyone of embodiments 1-8, further comprising sending a notice to a user based on the determined path feasibility.

Embodiment 10 is the method of anyone of embodiments 1-9, further comprising receiving a feedback from the user and updating the tape coverage path based on the feedback.

Embodiment 11 is the method of anyone of embodiments 1-10, wherein applying the tape onto the object surface further comprises loading the tape into a tab mechanism and creating a tab at an edge of the tape.

Embodiment 12 is the method of embodiment 11, wherein creating the tab comprises folding the edge of the tab.

Embodiment 13 is the method of embodiment 11 or 12, further comprises cutting the tape to create a new edge of the tape prior to creating the tab.

Embodiment 14 is an automated system to apply a tape onto an object surface, the system comprising:
an end-effector comprising a tape roll and a tabbing mechanism;
a vision system comprising one or more imaging sensors to obtain imaging data for the tape, the object surface, and the end-effector; and
a controller functionally connected to the end-effector and the vision system, wherein the controller is configured to;
   determine a tape coverage path on the object surface; and
   while moving the end-effector along a movement trajectory to apply, via the end-effector, the tape onto the object surface,
      determine a path feasibility of the tape coverage path;
      update the tape coverage path based on the determined path feasibility: and
      apply the tape onto the updated tape coverage path.

Embodiment 15 is the automated system of embodiment 14, wherein the tabbing mechanism further comprises a vacuum plate to hold an edge of the tape in place.

Embodiment 16 is the automated system of embodiment 15, wherein the vacuum plate comprises a first portion and a second portion foldable with respect to the first portion.

Embodiment 17 is the automated system of anyone of embodiments 14-16, further comprising a robot arm, wherein the end-effector is mounted on the robot arm.

Embodiment 18 is the automated system of anyone of embodiments 14-17, wherein the controller is further configured to determine a state of the tape on the object surface based on the imaging data from the vision system.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.” Furthermore, various exemplary embodiments have been described. These and other embodiments are within the scope of the following claims.

What is claimed is:

1. A method of applying a tape onto an object surface, the method comprising:
positioning a robot adjacent to the object surface, the robot comprising an end-effector, the end-effector comprising a tape applicator;
determining a tape coverage path to apply the tape on the object surface; and
while moving the end-effector along a movement trajectory,
determining a path feasibility of the tape coverage path:
updating the tape coverage path and the movement trajectory based on the determined path feasibility; and
applying the tape onto the updated tape coverage path.

2. The method of claim 1, wherein determining the tape coverage path on the object surface further comprises receiving specifications from a user regarding the tape coverage path in a three-dimensional (3D) model of the object surface.

3. The method of claim 1, further comprising obtaining, via a vision system, imaging data of the tape, the object surface, and the end-effector.

4. The method of claim 3, further comprising verifying a coverage of the tape on the tape coverage path based on the imaging data.

5. The method of claim 1, wherein determining the path feasibility comprises determining at least one of a collision point and a curvature section on the tape coverage path.

6. The method of claim 1, wherein determining the path feasibility further comprises detecting a deformation of the tape.

7. The method of claim 1, wherein determining the path feasibility further comprises detecting a movement of the object surface during the application of the tape.

8. The method of claim 1, wherein determining the path feasibility further comprises determining environmental conditions including an ambient temperature and an ambient humidity.

9. The method of claim 1, further comprising sending a notice to a user based on the determined path feasibility.

10. The method of claim 1, further comprising receiving a feedback from the user and updating the tape coverage path based on the feedback.

11. The method of claim 1, wherein applying the tape onto the object surface further comprises loading the tape into a tab mechanism and creating a tab at an edge of the tape.

12. The method of claim 11, wherein creating the tab comprises folding the edge of the tab.

13. The method of claim 11, further comprises cutting the tape to create a new edge of the tape prior to creating the tab.

14. An automated system to apply a tape onto an object surface, the system comprising:
an end-effector comprising a tape roll and a tabbing mechanism;
a vision system comprising one or more imaging sensors to obtain imaging data for the tape, the object surface, and the end-effector; and
a controller functionally connected to the end-effector and the vision system, wherein the controller is configured to:
determine a tape coverage path on the object surface; and
while moving the end-effector along a movement trajectory to apply, via the end-effector, the tape onto the object surface,
determine a path feasibility of the tape coverage path;
update the tape coverage path based on the determined path feasibility; and
apply the tape onto the updated tape coverage path.

15. The automated system of claim 14, wherein the tabbing mechanism further comprises a vacuum plate to hold an edge of the tape in place.

16. The automated system of claim 15, wherein the vacuum plate comprises a first portion and a second portion foldable with respect to the first portion.

17. The automated system of claim 14, further comprising a robot arm, wherein the end-effector is mounted on the robot arm.

18. The automated system of claim 14, wherein the controller is further configured to determine a state of the tape on the object surface based on the imaging data from the vision system.
